(19) United States
(12) Patent Application Publication
(10) Pub. No.: US 2023/0273819 A1
(43) Pub. Date: Aug. 31, 2023

(54) METHOD AND IOT CONTROLLER DEVICE FOR CONTEXT-BASED TASK MANAGEMENT IN IOT NETWORK

(71) Applicant: Samsung Electronics Co., Ltd., Suwon-si (KR)

(72) Inventors: Utkarsh UTKARSH, Ranchi (IN); Kushlam CHOWRASIYA, Kolkata (IN); Ashish BHATT, Bangalore (IN); Muthukumaran NATARAJAN, Bangalore (IN)

(21) Appl. No.: 18/186,505

(22) Filed: Mar. 20, 2023

Related U.S. Application Data
(63) Continuation of application No. PCT/KR2021/012601, filed on Sep. 15, 2021.

(30) Foreign Application Priority Data
Sep. 29, 2020 (IN) 202041042218

(51) Int. Cl. G06F 9/48

(52) U.S. Cl. CPC G06F 9/4881; G06F 9/485

(57) ABSTRACT

A method for context-based task management in an internet of things (IoT) network is provided. The method includes detecting an occurrence of at least one disruption while executing at least one ongoing task at an IoT device in the IoT network. The method includes identifying a contextual relationship between the at least one ongoing task and the at least one disruption. Further, the method includes performing one of continuing the at least one ongoing task at the IoT device, initiating at least one alternative task for the at least one ongoing task at the IoT device, and proceeding with at least one next task at the IoT device based on the contextual relationship between the at least one ongoing task and the at least one disruption.

### CROSS-REFERENCE TO RELATED APPLICATION(S)

This application is a continuation application, claiming priority under §365(c), of an International application No. PCT/KR2021/012601, filed on Sep. 15, 2021, which is based on and claims the benefit of Indian patent application number 202041042218, filed on Sep. 29, 2020, in the Indian Intellectual Property Office, the disclosure of which is incorporated by reference herein in its entirety.

### BACKGROUND

### 1. Field

The disclosure relates to electronic devices. More particularly, the disclosure relates to a method and an Internet of Thing (IoT) controller for context-based task management in an IoT network.

### 2. Description of Related Art

An IoT network refers to an interconnection of uniquely-identifiable embedded devices within an Internet infrastructure, where the embedded devices are called IoT devices. Ultimately, the IoT network is expected to result in new, wide-ranging types of applications in which virtually the IoT devices provides information about itself or its surroundings and/or may be controlled remotely via client devices over the Internet. With substantial increase of usage of IoT based appliances and personal devices, it is difficult for a user to track or manage the IoT devices when a disruption occurs while executing a task of the IoT devices due to a power outage, a network failure, etc. Upon resolving a power outage or a network failure, the IoT devices resumes an execution of the task from a point from where is stops as per an existing method. In another existing method, the IoT devices restarts or skip the task execution.

The above information is presented as background information only to assist with an understanding of the disclosure. No determination has been made, and no assertion is made, as to whether any of the above might be applicable as prior art with regard to the disclosure.

### SUMMARY

In an example scenario of cooking food using an oven, a power failure occurs while cooking the food. At a time of the power failure, the food is partially cooked and heat inside the oven is enough to cook the food. The power failure resolves in 15 min, where the food is already cooked within this time using the heat inside the oven. However, the oven resumes the cooking upon resolving the power failure, which further cause to overcook the food. Therefore, a user experience deteriorates upon resumption of execution of the task. Along with a poor user experience the IoT devices are unnecessarily consumes an energy while results in a wastage of energy. Thus, it is desired to address the above-mentioned shortcomings or at least provide a useful alternative.

Aspects of the disclosure are to address at least the above-mentioned problems and/or disadvantages and to provide at least the advantages described below. Accordingly, an aspect of the disclosure is to provide a method for context-based task management in an IoT network. The method includes detecting, by an IoT controller device, an occurrence of at least one disruption while executing at least one ongoing task at an IoT device in the IoT network. Further, the method includes identifying, by the IoT controller device, a contextual relationship between the at least one ongoing task and the at least one disruption. Further, the method includes performing, by the IoT controller device, one of continuing the at least one ongoing task at the IoT device based on the contextual relationship between the at least one ongoing task and the at least one disruption, initiating at least one alternative task for the at least one ongoing task at the IoT device based on the contextual relationship between the at least one ongoing task and the at least one disruption, and proceeding with at least one next task at the IoT device based on the contextual relationship between the at least one ongoing task and the at least one disruption.

Additional aspects will be set forth in part in the description which follows and, in part, will be apparent from the description, or may be learned by practice of the presented embodiments.

In accordance with an aspect of the disclosure, a method for context-based task management in an IoT network is provided. The method includes detecting, by an IoT controller device, a plurality of tasks assigned to at least one IoT device in the IoT network. Further, the method includes detecting, by the IoT controller device, an occurrence of at least one disruption while executing at least one ongoing task from the plurality of tasks assigned to the at least one IoT device. Further, the method includes identifying, by the IoT controller device, whether the contextual relationship is present between the at least one ongoing task and the at least one disruption. Further, the method includes performing, by the IoT controller device, one of modifying the plurality of tasks assigned to the at least one IoT device in response to determining that the contextual relationship is present between the at least one ongoing task and the at least one disruption, and continuing the at least one ongoing task at the at least one IoT device in response to determining that the contextual relationship is not present between the at least one ongoing task and the at least one disruption.

In accordance with another aspect of the disclosure, an IoT controller device for context-based task management in the IoT network is provided. The IoT controller device includes a task controller, a memory, a processor, where the task controller is coupled to the memory and the processor. The task controller is configured to detect the occurrence of at least one disruption while executing at least one ongoing task at an IoT device in the IoT network. The task controller is configured to determine the contextual relationship between the at least one ongoing task and the at least one disruption. The task controller is configured to perform one of continuing the at least one ongoing task at the IoT device based on the contextual relationship between the at least one ongoing task and the at least one disruption, initiating the at least one alternative task for the at least one ongoing task at the IoT device based on the contextual relationship between the at least one ongoing task and the at least one disruption, and proceeding with the at least one next task at the IoT device based on the contextual relationship between the at least one ongoing task and the at least one disruption.

In accordance with another aspect of the disclosure, an IoT controller device for context-based task management in the IoT network is provided. The IoT controller device includes the task controller, the memory, the processor, where the task controller is coupled to the memory and the processor. The task controller is configured to detect the plurality of tasks assigned to at least one IoT device in the IoT network. The task controller is configured to detect the occurrence of at least one disruption while executing the at least one ongoing task from the plurality of tasks assigned to the at least one IoT device. The task controller is configured to determine whether the contextual relationship is present between the at least one ongoing task and the at least one disruption. The task controller is configured to perform one of modifying the plurality of tasks assigned to the at least one IoT device, in response to determining that the contextual relationship is present between the at least one ongoing task and the at least one disruption, and continuing the at least one ongoing task at the at least one IoT device, in response to determining that the contextual relationship is not present between the at least one ongoing task and the at least one disruption.

Other aspects, advantages, and salient features of the disclosure will become apparent to those skilled in the art from the following detailed description, which, taken in conjunction with the annexed drawings, discloses various embodiments of the disclosure

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A is a block diagram of a system for context-based task management in an IoT network, according to an embodiment of the disclosure;

FIG. 1B is a block diagram of a task controller for context-based task management at an IoT device, according to an embodiment of the disclosure;

FIG. 2 is a flow diagram illustrating a method for context-based task management in an IoT network, according to an embodiment of the disclosure;

FIG. 3 is a flow diagram illustrating a method for context-based task management in an IoT network, according to an embodiment of the disclosure;

FIG. 4 is a flow diagram illustrating operations in the method of generating a contextual state by a contextual state generator, according to an embodiment of the disclosure;

FIG. 5 is a flow diagram illustrating operations in the method of generating a contextual state by a contextual state generator, according to an embodiment of the disclosure;

FIG. 6 is a flow diagram illustrating operations in the method of goal auditing, according to an embodiment of the disclosure;

FIG. 7 is a flow diagram illustrating operations in the method of identifying an action by a task optimizer, according to an embodiment of the disclosure;

FIG. 8 is a flow diagram illustrating operations in the method of selecting a relevant task by a task mapper, according to an embodiment of the disclosure;

FIG. 9 illustrates an example scenario of optimizing an ongoing task of a washing machine, according to an embodiment of the disclosure;

FIG. 10 illustrates an example scenario of optimizing the ongoing task of a coffee maker, according to an embodiment of the disclosure;

FIG. 11 illustrates example scenarios of optimizing the ongoing task of an oven, according to an embodiment of the disclosure;

FIG. 12 illustrates example scenarios of optimizing the ongoing task of an oven, according to an embodiment of the disclosure;

FIG. 13 illustrates an example scenario of optimizing the ongoing task of a television, according to an embodiment of the disclosure; and

FIG. 14 illustrates an example scenario of optimizing the ongoing task of an air conditioner, according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be for clarity and conciseness. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments of the disclosure can be practiced and to further enable those skilled in the art to practice the embodiments of the disclosure. Accordingly, the examples should not be construed as limiting the scope of the embodiments of the disclosure.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As is traditional in the field, embodiments of the disclosure may be described and illustrated in terms of blocks which carry out a described function or functions. In some embodiments, these blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits, and the like, and may optionally be driven by firmware. The circuits may, for example, be embodied in one or more semiconductor chips, or on substrate supports such as printed circuit boards and the like. In other embodiments, the circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments of the disclosure may be physically separated into two or more interacting and discrete blocks without departing from the scope of the disclosure. The blocks of the embodiments of the disclosure may be physically combined into more complex blocks without departing from the scope of the disclosure.

The principal object of the embodiments of the disclosure is to provide a method and an IoT controller device for context-based task management in an IoT network. In response to managing a task based on a context, the proposed method improves a user experience in managing a disruption and a resumption of an ongoing task execution at an IoT device. Further, the proposed method improves an energy management at an IoT device by executing an optimized ongoing task at the IoT device.

In an object of the embodiments of the disclosure is to identify parameter associated with a disruption such as a duration of the disruption, in response to detecting an occurrence of the disruption in executing the ongoing task at the IoT device due to a power cut, or a network failure, etc.

In another object of the embodiments of the disclosure is to optimize an ongoing task for the execution based on the parameter associated with the disruption, a goal of the task, a user context, a consistency support of the task and an environmental condition.

In still another object of the embodiments of the disclosure is to execute an optimized ongoing task upon detecting that the power cut, or the network failure, etc. at the IoT device has been resolved.

Another object of the embodiments of the disclosure is to improve a user experience in managing the disruption and resumption of the ongoing task execution at IoT device.

An object of the embodiments of the disclosure is to improve an energy management at an IoT device by executing the optimized ongoing task upon detecting that a power cut, or a network failure, etc. at the IoT device has been resolved.

Accordingly, the embodiments of the disclosure provide a method for context-based task management in an IoT network. The method includes detecting, by an IoT controller device, an occurrence of at least one disruption while executing at least one ongoing task at an IoT device in the IoT network. Additionally, the method includes identifying, by the IoT controller device, a contextual relationship between the at least one ongoing task and the at least one disruption. Still further, the method includes performing, by the IoT controller device, one of: continuing the at least one ongoing task at the IoT device based on the contextual relationship between the at least one ongoing task and the at least one disruption, initiating at least one alternative task for the at least one ongoing task at the IoT device based on the contextual relationship between the at least one ongoing task and the at least one disruption, and proceeding with at least one next task at the IoT device based on the contextual relationship between the at least one ongoing task and the at least one disruption.

In an embodiment of the disclosure, where a contextual relationship between the at least one ongoing task and the at least one disruption is determined based on at least one parameter associated with the at least one disruption, at least one parameter associated with the at least one ongoing task and a context of the IoT device.

In another embodiment of the disclosure, where the at least one parameter associated with the disruption comprises a type of the disruption, a duration of the disruption, a timestamp of the disruption.

In yet another embodiment of the disclosure, where the at least one parameter associated with an ongoing task comprises a previous task of the ongoing task, subsequent tasks of the ongoing task, a status of the ongoing task, a duration of the ongoing task, a consistency of the ongoing task, and a sequence of the ongoing task.

In an embodiment of the disclosure, where the context of the IoT device comprises at least one an environmental condition around the IoT device, a proximity of an IoT device to a user of the IoT device, an action performing by the user, and an operation condition of the IoT device.

In another embodiment of the disclosure, where proceeding with at least one next task at an IoT device based on the contextual relationship between the at least one ongoing task and the at least one disruption, includes determining, by the IoT controller device, that the at least one ongoing task is completed based on the contextual relationship between the at least one ongoing task and the at least one disruption, and performing, by the by the IoT controller device, one of: assigning the at least one next task to the at least one IoT device based on at least one parameter associated with the at least one ongoing task, in response to determining that at least one ongoing task is completed, and modifying the at least one ongoing task based on a context of the at least one IoT device, at least one parameter associated with the at least one disruption and the at least one parameter associated with the at least one ongoing task, in response to determining that the at least one ongoing task is completed

In yet another embodiment of the disclosure, where initiating at least one alternative task for at least one ongoing task at an IoT device based on the contextual relationship between the at least one ongoing task and the at least one disruption, includes determining a goal of the at least one ongoing task based on a context of the at least one ongoing task, estimating a remaining time to achieve the goal of the at least one ongoing task based on at least one parameter associated with the at least one disruption, and generating the new list of tasks for assigning to the IoT device based on the remaining time to achieve the goal, the goal of the at least one ongoing task and a context of the IoT device

In still another embodiment of the disclosure, where generating a new list of tasks for assigning to an IoT device based on the remaining time to achieve the goal, a goal of the at least one ongoing task and the context of the IoT device, comprises performing, by the IoT device, one of: adjusting a duration for an execution of the at least one ongoing task based on the remaining time to achieve the goal, and adjusting at least one device setting configured for the execution of the at least one ongoing task based on the remaining time to achieve the goal of the at least one task.

Accordingly, the embodiments of the disclosure herein provide a method for context-based task management in an IoT network. The method includes detecting, by an IoT controller device, a plurality of tasks assigned to at least one IoT device in the IoT network. Additionally, the method includes detecting, by the IoT controller device, an occurrence of at least one disruption while executing at least one ongoing task from the plurality of tasks assigned to the at least one IoT device. Further, the method includes determining, by the IoT controller device, whether the contextual relationship is present between the at least one ongoing task and the at least one disruption. Still further, the method includes performing, by the IoT controller device, one of: modifying the plurality of tasks assigned to the at least one IoT device in response to determining that the contextual relationship is present between the at least one ongoing task and the at least one disruption, and continuing the at least one ongoing task at the at least one IoT device in response to determining that the contextual relationship is not present between the at least one ongoing task and the at least one disruption.

In another embodiment of the disclosure, where determining, by an IoT controller device, whether the contextual relationship is present between the at least one ongoing task and the at least one disruption, comprises: determining, by the IoT controller device, a context of the at least one IoT device based on at least one parameter associated with the at least one disruption and at least one parameter associated with the at least one ongoing task, determining, by the IoT controller device, whether at least one of the at least one ongoing task and at least one next task of the plurality of tasks is disturbed based on the context of the at least one IoT device, and performing, by the IoT controller device, one of: identifying that the contextual relationship is present between the at least one ongoing task and the at least one disruption, in response to determining that the at least one of the at least one ongoing task and at least one next task of the plurality of tasks is disturbed, and identifying that the contextual relationship is not present between the at least one ongoing task and the at least one disruption, in response to determining that the at least one of the at least one ongoing task and at least one next task of the plurality of tasks is not disturbed

In still another embodiment of the disclosure, where modifying, by an IoT controller device, a plurality of tasks, includes determining, by the IoT controller device, whether the at least one ongoing task is completed based on at least one parameter associated with the at least one disruption and at least one parameter associated with the at least one ongoing task, performing, by the IoT controller device, one of: assigning at least one next task of the plurality of tasks to the at least one IoT device based on the at least one parameter associated with the at least one ongoing task, in response to determining that at least one ongoing task is completed, modifying the at least one ongoing task based on a context of the at least one IoT device, the at least one parameter associated with the at least one disruption and the at least one parameter associated with the at least one ongoing task, in response to determining that the at least one ongoing task is completed, and modifying the plurality of tasks by generating a new list of tasks for the at least one IoT device based on at least one of the context of the at least one IoT device, the at least one parameter associated with the at least one disruption and the at least one parameter associated with the at least one ongoing task, in response to determining that the at least one ongoing task is not completed, and assigning the new list of tasks to the at least one IoT device.

In an embodiment of the disclosure, where modifying a plurality of tasks by generating a new list of tasks for at least one IoT device based on at least one of the context of the at least one IoT device, the at least one parameter associated with the disruption and the at least one parameter associated with the at least one ongoing task, includes determining a goal of the at least one ongoing task based on the context of the at least one ongoing task, estimating a remaining time to achieve the goal of the at least one ongoing task based on the at least one parameter associated with the disruption, and generating the new list of tasks for assigning to the at least one IoT device based on the remaining time to achieve the goal, the goal of the at least one ongoing task and the context of the at least one IoT device.

Unlike existing methods and systems, the proposed method allows an IoT controller device to identify a parameter associated with a disruption such as a duration of the disruption, based on detecting an occurrence of the disruption in executing the ongoing task at the IoT device due to power cut, network failure, etc. Further, the IoT controller device optimizes the ongoing task for the execution based on the parameter associated with the disruption, a goal of the task, a user context, a consistency support of the task and an environmental condition. Still further, the IoT controller device executes the optimized ongoing task upon detecting that the power, network failure, etc. has been resolved. The proposed method improves a user experience in managing the disruption and resumption of the ongoing task execution at IoT device. Moreover, the proposed method improves an energy management at the IoT device by executing the optimized ongoing task upon detecting that the power, network failure, etc. has been resolved.

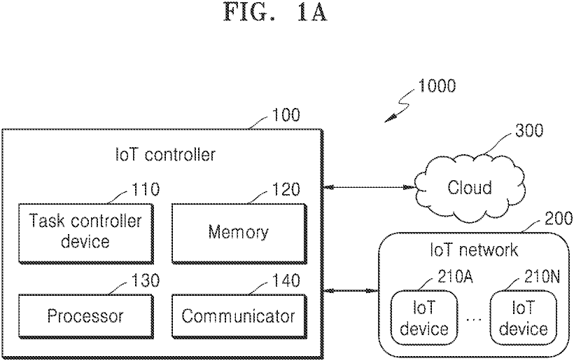

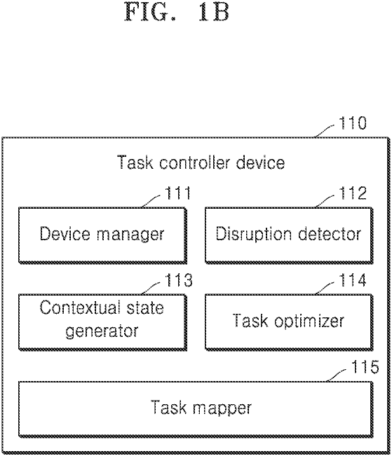

Referring now to the drawings, and more particularly to FIGS. 1A, 1B, 2 to 14, there are shown embodiments of the disclosure.

FIG. 1A is a block diagram of a system 1000 for context-based task management in an IoT network 200, according to an embodiment of the disclosure.

Referring to FIG. 1A, in an embodiment of the disclosure, the system 1000 includes an IoT controller device 100, an IoT network 200 and a cloud 300 (i.e., an IoT server). In an embodiment, the IoT controller device 100 is coupled to at least one IoT device 210A-210N (herein labelled as 210). Examples of an IoT controller device 100 are, but not limited to a smart phone, a tablet computer, a Personal Digital Assistance (PDA), the IoT device 210, and the like. In an embodiment of the disclosure, the IoT controller device 100 includes a task controller 110, at least one memory 120, at least one processor 130, and a communicator 140. In another embodiment, the task controller 110 is coupled to the at least one memory 120 and the at least one processor 130. In an embodiment, the task controller 110 and the at least one processor 130 may be combined as a hardware processor.

In yet another embodiment, the task controller 110 is configured to detect a plurality of tasks assigned to the at least one IoT device 210 in the IoT network 200. Examples for the tasks assigned to the at least one IoT device 210 are, but not limited to soaking clothes, washing clothes, preparing coffee, baking cake, air conditioning, and the like. In an embodiment of the disclosure, the task controller 110 is configured to fetch information on a service or the plurality of tasks assigned to the at least one IoT device 210 from the cloud 300 for detecting the plurality of tasks, based on detecting an input (e.g., a user input) for initiation of the service or the plurality of tasks at the at least one IoT device 210. In an embodiment of the disclosure, the service includes the plurality of tasks where each task has a sequence of executions. For example, when the service is a daily wash option in a washing machine, the daily wash option includes the tasks such as soaking, washing, rinsing, and spinning. In still another embodiment, the task controller 110 is configured to detect an occurrence of at least one disruption while executing at least one ongoing task from the plurality of tasks assigned to the at least one IoT device 210.

In an embodiment, the task controller 110 is configured to identify at least one parameter associated with the disruption, where the at least one parameter associated with the disruption includes a type of the disruption, a duration of the disruption, and a timestamp of the disruption. Examples for the type of the disruption are, but not limited to a disruption in power, a safety disruption, a disruption in network connectivity, a disruption due to low data storage space, a disruption due to an end of internet data package, a disruption due to low amount of sugar/coffee/water/milk in a container, and the like. In another embodiment, the task controller 110 is configured to identify at least one parameter associated with the at least one ongoing task, where the at least one parameter associated with the ongoing task includes a previous task of the ongoing task, subsequent tasks of the ongoing task (i.e., next tasks to be executed subsequently to the ongoing task), a status of the ongoing task, a duration of the ongoing task, a consistency of the ongoing task, and a sequence of the ongoing task. A task is consistent when the task has to be cohesively adapted for achieving an old/new goal for an old/updated context upon resuming the execution of the task from a disruption. In an embodiment of the disclosure, the consistency of the ongoing task is identified based on the previous task, the next task, the duration of the ongoing task, and a task nature of the ongoing task. In an embodiment of the disclosure, the task nature is identified based on a device type (e.g., device for washing, device for watching movie, etc.) and a service type (e.g. washing, playing movie, etc.). For example, a completion status of the ongoing task is an example for the status of the ongoing task. A status of a task indicates whether the execution of the task is completed, or ongoing, or pending to initiate.

In another embodiment, the task controller 110 is configured to identify a context of the at least one IoT device 210 based on the at least one parameter associated with the disruption and the at least one parameter associated with the at least one ongoing task. In an embodiment of the disclosure, the context of the IoT device 210 includes at least one an environmental condition around the IoT device 210, a proximity of the IoT device 210 to a user of the IoT device 210, an action performing by the user, and an operation condition of the IoT device 210. Examples for the environmental condition are, but not limited to humidity, ambient temperature, ambiance light, a purity of air, and the like. Other examples for the action performing by the user are, but not limited to a phone call attending by the user, a lid of an oven opening by the user, and the like. Still other examples for the operation condition of the IoT device 210 are, but not limited to a safe condition of the IoT device 210, an unsafe condition of the IoT device 210, and the like.

The task controller 110 is configured to identify whether the at least one of the at least one ongoing task and at least one next task of the plurality of tasks is disturbed based on the context of the at least one IoT device 210. In an embodiment, the task controller 110 is configured to continue the at least one ongoing task at the at least one IoT device 210 based on identifying that none of the at least one ongoing task and the at least one next task is disturbed. In another embodiment, the task controller 110 is configured to modify the plurality of tasks assigned to the at least one IoT device 210 based on identifying that the at least one of the at least one ongoing task and the at least one next task is disturbed.

In an embodiment of the disclosure, the task controller 110 is configured to identify whether the at least one ongoing task is completed based on the at least one parameter associated with the disruption and the at least one parameter associated with the at least one ongoing task. In another embodiment, the task controller 110 is configured to assign the at least one next task among the plurality of tasks to be executed subsequently to the at least one ongoing task to the at least one IoT device 210 based on the at least one parameter associated with the at least one ongoing task, based on identifying that at least one ongoing task is completed. In yet another embodiment of the disclosure, the task controller 110 is configured to modify the at least one ongoing task based on the context of the at least one IoT device, the at least one parameter associated with the at least one disruption and the at least one parameter associated with the at least one ongoing task, based on identifying that the at least one ongoing task is completed.

In still another embodiment, the task controller 110 is configured to modify the plurality of tasks by generating a new list of tasks for the at least one IoT device 210 based on at least one of the contexts of the at least one IoT device 210, the at least one parameter associated with the disruption and the at least one parameter associated with the at least one ongoing task, based on identifying that the at least one ongoing task is not completed. Further, the task controller 110 is configured to assign the new list of tasks to the at least one IoT device 210.

In one embodiment of the disclosure, the task controller 110 is configured to identify a goal (i.e., objective/aim) of the at least one ongoing task based on the context of the at least one ongoing task. Further, the task controller 110 is configured to estimate a remaining time to achieve the goal of the at least one ongoing task based on the at least one parameter associated with the disruption. Still further, the task controller 110 is configured to generate the new list of tasks for assigning to the at least one IoT device 210 based on the remaining time to achieve the goal, the goal of the at least one ongoing task and the context of the at least one IoT device 210. In another embodiment of the disclosure, the task controller 110 is configured to generate a contextual state includes the goal, the remaining time to achieve the goal, the previous task, the next task, the type of the disruption and duration of the disruption.

In another embodiment of the disclosure, the context of the at least one IoT device 210 includes the generated contextual state. The task controller 110 is configured to optimize the at least one ongoing task based on the contextual state. In an embodiment of the disclosure, the task controller 110 is configured to adjust a duration for an execution of the at least one ongoing task based on the remaining time to achieve the goal for optimizing the at least one ongoing task. In yet another embodiment of the disclosure, task controller 110 is configured to adjust at least one device setting configured for the execution of the at least one ongoing task based on the remaining time to achieve the goal of the at least one task for optimizing the at least one ongoing task. Some examples for the device setting are but not limited to a temperature, a speed in playing a media, a flow of water, a speed of rotation of motor, a brightness of a light, a color of a light, and the like.

In yet another embodiment of the disclosure, the task controller 110 is configured to identifying a contextual relationship between the at least one ongoing task and the at least one disruption. In an example, the contextual relationship between the at least one ongoing task and the at least one disruption is identified based on at least one parameter associated with the at least one disruption, at least one parameter associated with the at least one ongoing task and a context of the IoT device 210. The task controller 110 is configured to perform one of: continuing the at least one ongoing task at the IoT device 210, initiating at least one alternative task for the at least one ongoing task at the IoT device 210, and proceeding with at least one next task at the IoT device 210 based on the contextual relationship between the at least one ongoing task and the at least one disruption based on the contextual relationship between the at least one ongoing task and the at least one disruption.

In one embodiment of the disclosure, the task controller 110 is configured to identify that the at least one ongoing task is completed based on the contextual relationship between the at least one ongoing task and the at least one disruption. In another embodiment, the task controller 110 is configured to assign the at least one next task to the at least one IoT device 210 based on the at least one parameter associated with the at least one ongoing task, based on identifying that at least one ongoing task is completed. In yet another embodiment of the disclosure, the task controller 110 is configured to modify the at least one ongoing task based on the context of the at least one IoT device 210, the at least one parameter associated with the at least one disruption and the at least one parameter associated with the at least one ongoing task, based on identifying that the at least one ongoing task is completed.

In still another embodiment of the disclosure, to initiate the at least one alternative task for the at least one ongoing task at the IoT device 210 based on the contextual relationship between the at least one ongoing task and the at least one disruption, the task controller 110 is configured to generate the new list of tasks for assigning to the IoT device 210 based on the remaining time to achieve the goal, the goal of the at least one ongoing task and a context of the IoT device 210.

The task controller 110 is configured to identifying whether the contextual relationship is present between the at least one ongoing task and the at least one disruption. Further, the task controller 110 is configured to modify the plurality of tasks assigned to the at least one IoT device 210 based on identifying that the contextual relationship is present between the at least one ongoing task and the at least one disruption. Still further, the task controller 110 is configured to continuing the at least one ongoing task at the at least one IoT device 210 based on identifying that the contextual relationship is not present between the at least one ongoing task and the at least one disruption.

In one embodiment of the disclosure, the task controller 110 is configured to identify that the contextual relationship is present between the at least one ongoing task and the at least one disruption, based on identifying that the at least one of the at least one ongoing task and at least one next task of the plurality of tasks is disturbed. In another embodiment, the task controller 110 is configured to identify that the contextual relationship is not present between the at least one ongoing task and the at least one disruption, based on identifying that the at least one of the at least one ongoing task and at least one next task of the plurality of tasks is not disturbed.

The at least one memory 120 may be configured to include non-volatile storage elements. Some examples of such non-volatile storage elements may include magnetic hard discs, optical discs, floppy discs, flash memories, forms of an Electrically Programmable Memory (EPROM) or an Electrically Erasable and Programmable Memory (EEPROM), and the like.

In addition, the at least one memory 120 may, in some examples, be considered a non-transitory storage medium. The term “non-transitory” may indicate that the storage medium is not embodied in a carrier wave or a propagated signal. However, the term “non-transitory” should not be interpreted that the at least one memory 120 is non-movable. In some examples, the at least one memory 120 may be configured to store larger amounts of information than the at least one memory 120 respectively. In certain examples, a non-transitory storage medium may store data that may, over time, change (e.g., in Random Access Memory (RAM) or cache).

The at least one processor 130 may be configured to execute instructions stored in the at least one memory 120. The communicator 140 may be configured to communicate internally between hardware components in the IoT controller device 100. Further, the communicator 140 may be configured to facilitate the communication between the IoT controller device 100 and other devices (e.g., cloud 300, IoT devices 210 etc.)

Although the FIG. 1A shows the hardware components of the system 1000 but it is to be understood that other embodiments are not limited thereon. In other embodiments of the disclosure, the system 1000 may include less or more number of components. Further, the labels or names of the components are used only for illustrative purpose and does not limit the scope of the disclosure. One or more components may be combined together to perform same or substantially similar function for the context-based task management in the IoT network 200.

FIG. 1B is a block diagram of the task controller 110 for the context-based task management at the IoT device 210, according to an embodiment of the disclosure.

Referring to FIG. 1B, in an embodiment of the disclosure, the task controller 110 includes a device manager 111, a disruption detector 112, a contextual state generator 113, a task optimizer 114, and a task mapper 115. The device manager 111 detects a plurality of tasks assigned to the at least one IoT device 210 in an IoT network 200. In an embodiment of the disclosure, the device manager 111 fetches the information on the service and/or the plurality of tasks assigned to the at least one IoT device 210 and/or device setting from a cloud 300 for detecting the plurality of tasks, based on detecting the input for initiation of the service or the plurality of tasks at the at least one IoT device 210. The device manager 111 identifies the at least one parameter (also called as task parameter) associated with the at least one ongoing task. In an embodiment, the device manager 111 executes the tasks based on instruction from contextual state generator 113 and the task mapper 115.

In one embodiment, the disruption detector 112 detects the occurrence of the at least one disruption while executing the at least one ongoing task at the at least one IoT device 210. In another embodiment of the disclosure, the disruption detector 112 detects the occurrence of the at least one disruption and a time of resumption (e.g. power cut for 20 minutes or washing machine lid was open for 15 minutes, etc.) of the service or plurality of task based a user interruption (e.g. a user is away from the IoT device 210), an environmental interruption (e.g. a change in humidity in the ambiance), a service status (e.g., power cut, network issues, etc.). In yet another embodiment of the disclosure, the disruption detector 112 communicates with the device manager 111 to identify the duration of the task, start time of the task, an end time of the task, a status of the task etc. to detect the occurrence of the at least one disruption in the task execution. Further, the disruption detector 112 identifies the end of disruption by sending a heartbeat signal to the device manager 111. Still further, the disruption detector 112 identifies the at least one parameter (also called as disruption parameter) associated with the disruption.

In an embodiment, the contextual state generator 113 identifies the context of the at least one IoT device 210 based on the at least one parameter associated with the disruption and the at least one parameter associated with the at least one ongoing task. Further, the contextual state generator 113 identify whether the at least one of the at least one ongoing task and at least one next task of the plurality of tasks is disturbed based on the context of the at least one IoT device 210. In another embodiment, the contextual state generator 113 instructs the at least one IoT device 210 to continue the execution of the at least one ongoing task based on identifying that none of the at least one ongoing task and the at least one next task is disturbed. In yet another embodiment, the task optimizer 114 modifies the plurality of tasks assigned to the at least one IoT device 210 based on identifying that the at least one of the at least one ongoing task and the at least one next task is disturbed.

In one embodiment of the disclosure, the task optimizer 114 identifies whether the at least one ongoing task is completed based on the at least one parameter associated with the disruption and the at least one parameter associated with the at least one ongoing task. In another embodiment, the task mapper 115 assigns the at least one next task of the plurality of tasks to the at least one IoT device 210 based on the at least one parameter associated with the at least one ongoing task, based on identifying that at least one ongoing task is completed. In still another embodiment, the task optimizer 114 modifies the plurality of tasks by generating the new list of tasks for the at least one IoT device 210 based on at least one of the context of the at least one IoT device 210, the at least one parameter associated with the disruption and the at least one parameter associated with the at least one ongoing task, based on identifying that the at least one ongoing task is not completed. Further, the task mapper 115 assigns the new list of tasks to the at least one IoT device 210.

The contextual state generator 113 identifies the goal of the at least one ongoing task based on the context of the at least one ongoing task. In an embodiment, the contextual state generator 113 estimates the remaining time to achieve the goal of the at least one ongoing task based on the at least one parameter associated with the disruption. In another embodiment, the task optimizer 114 generates the new list of tasks for assigning to the at least one IoT device 210 based on the remaining time to achieve the goal, the goal of the at least one ongoing task and the context of the at least one IoT device 210.

In one embodiment of the disclosure, the contextual state generator 113 generates the contextual state includes the goal, the remaining time to achieve the goal, the previous task, the next task, the type of the disruption and duration of the disruption, based on detecting that the at least one ongoing task is consistent. In another embodiment of the disclosure, the contextual state generator 113 continues the normal execution of the plurality of tasks, based on detecting that the at least one ongoing task is not consistent. The task optimizer 114 optimizes the at least one ongoing task based on the contextual state. In yet another embodiment of the disclosure, the task optimizer 114 adjusts the duration for the execution of the at least one ongoing task based on the remaining time to achieve the goal for optimizing the at least one ongoing task. In another embodiment of the disclosure, the task optimizer 114 adjusts the at least one device setting configured for the execution of the at least one ongoing task based on the remaining time to achieve the goal of the at least one task for optimizing the at least one ongoing task. Further, the task mapper 115 instructs the device manager 111 to control operation in the at least one IoT device 210 as per the at least one optimized ongoing task.

In still another embodiment of the disclosure, the task optimizer 114 identifies whether the goal has been met based on the duration of the disruption. The task optimizer 114 calculates a time value to increase or to decrease to achieve the goal based on the remaining time to achieve the goal of the at least one task and predicts an action, when the goal has not been met. In an embodiment, the task optimizer 114 does not change the time for executing the ongoing task, when the goal has been met. In another embodiment of the disclosure, the task optimizer 114 adjusts the at least one device setting configured for the execution of the at least one ongoing task based on the remaining time to achieve the goal of the at least one task and predicts the action, when the goal has not been met. In another embodiment of the disclosure, the task optimizer 114 predicts the action for the ongoing task, when the goal has been met. In another embodiment of the disclosure, the action may be a change, a restart, a skip, or a continuation of the ongoing task. In an embodiment of the disclosure, the action may be an increase, a decrease or no change of the device setting. In yet another embodiment, the task optimizer 114 send the action and the time value to the task mapper 115. The task mapper 115 analyses the time value and the action. Further, the task mapper 115 maps the optimized task to a relevant task similar to the optimized task, where relevant task is available for the at least one IoT device 210 to executes. Still further, the task mapper 115 instructs the device manager 111 to initiate the relevant task and the subsequent tasks (i.e. the next tasks) at the at least one IoT device 210.

Although FIG. 1B shows the hardware components of the task controller 110 but it is to be understood that other embodiments are not limited thereon. In some embodiments of the disclosure, the task controller 110 may include less or more number of components. Additionally, the labels or names of the components are used only for illustrative purpose and does not limit the scope of the disclosure. One or more components may be combined together to perform same or substantially similar function for the context-based task management at the IoT device 210.

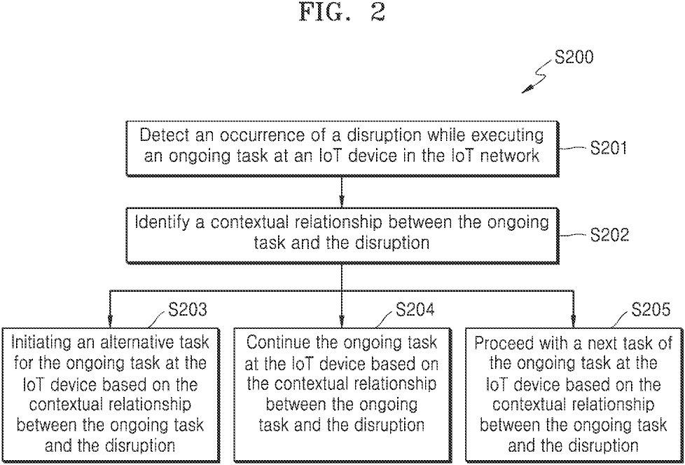

FIG. 2 is a flow diagram S200 illustrating a method for the context-based task management in the IoT network 200, according to an embodiment of the disclosure. Referring to the flow diagram S200 referring to FIG. 2, in operation S201, the method includes detecting an occurrence of at least one disruption while executing at least one ongoing task at an IoT device 210 in the IoT network 200. In one embodiment of the disclosure, the method allows the disruption detector 112 to detect the occurrence of the at least one disruption while executing at least one ongoing task at an IoT device 210 in the IoT network 200. In operation S202, the method, for example, includes identifying the contextual relationship between the at least one ongoing task and the at least one disruption. In another embodiment of the disclosure, the method allows the contextual state generator 113 to identify the contextual relationship between the at least one ongoing task and the at least one disruption.

In operation S203, the method, for example, includes initiating the at least one alternative task for the at least one ongoing task at the IoT device 210 based on the contextual relationship between the at least one ongoing task and the at least one disruption. In an embodiment of the disclosure, the method allows the task mapper 115 to initiate the at least one alternative task for the at least one ongoing task at the IoT device 210 based on the contextual relationship between the at least one ongoing task and the at least one disruption. In operation S204, the method, for example, includes continuing the at least one ongoing task at the IoT device 210 based on the contextual relationship between the at least one ongoing task and the at least one disruption. In an embodiment of the disclosure, the method allows the contextual state generator 113 to continue the at least one ongoing task at the IoT device 210 based on the contextual relationship between the at least one ongoing task and the at least one disruption. In operation S205, the method includes proceeding with at least one next task at the IoT device 210 based on the contextual relationship between the at least one ongoing task and the at least one disruption. In yet another embodiment of the disclosure, the method allows the task mapper 115 to proceed with the at least one next task at the IoT device 210 based on the contextual relationship between the at least one ongoing task and the at least one disruption.

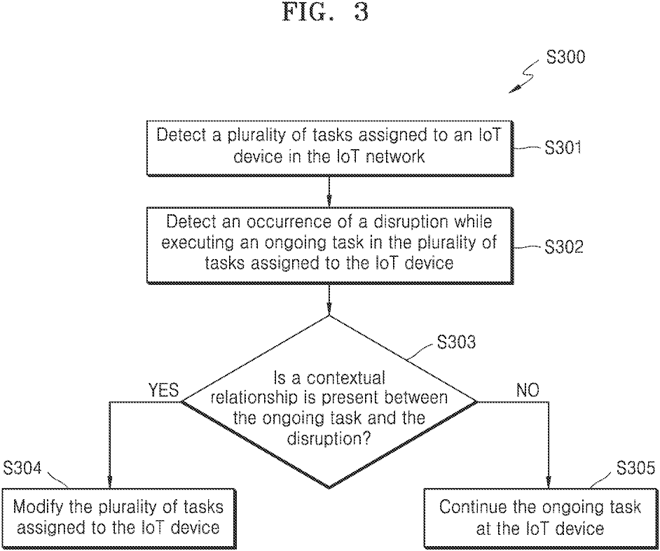

FIG. 3 is a flow diagram S300 illustrating a method for the context-based task management in the IoT network 200, according to an embodiment of the disclosure.

Referring to FIG. 3, the flow diagram S300, in operation S301, the method includes detecting the plurality of tasks assigned to the IoT device 210 in the IoT network 200. In one embodiment of the disclosure, the method allows the device manager 111 to detect the plurality of tasks assigned to the IoT device 210 in the IoT network 200. In operation S302, the method includes detecting the occurrence of the disruption while executing the ongoing task in the plurality of tasks assigned to the IoT device 210. In another embodiment of the disclosure, the method allows the disruption detector 112 to detect the occurrence of the disruption while executing the ongoing task in the plurality of tasks assigned to the IoT device 210. In operation S303, the method, for example, includes identifying whether the contextual relationship is present between the at least one ongoing task and the at least one disruption. In an embodiment of the disclosure, the method allows the contextual state generator 113 to identify whether the contextual relationship is present between the at least one ongoing task and the at least one disruption.

In operation S304, the method, for example, includes modifying the plurality of tasks assigned to the IoT device 210, based on identifying that the contextual relationship is present between the at least one ongoing task and the at least one disruption. In an embodiment of the disclosure, the method allows the task optimizer 114 to modify the plurality of tasks assigned to the IoT device 210, based on identifying that the contextual relationship is present between the at least one ongoing task and the at least one disruption. In operation S305, the method includes continuing the ongoing task at the IoT device 210, based on identifying that the contextual relationship is not present between the at least one ongoing task and the at least one disruption. In another embodiment of the disclosure, the method allows the contextual state generator 113 to continue the ongoing task at the IoT device 210, based on identifying that the contextual relationship is not present between the at least one ongoing task and the at least one disruption.

The various actions, acts, blocks, operations, or the like in the flow diagram S200 or the flow diagram S300 may be performed in the order presented, in a different order or simultaneously. Further, in some embodiments of the disclosure, some of the actions, acts, blocks, operations, or the like may be omitted, added, modified, skipped, or the like without departing from the scope of the disclosure.

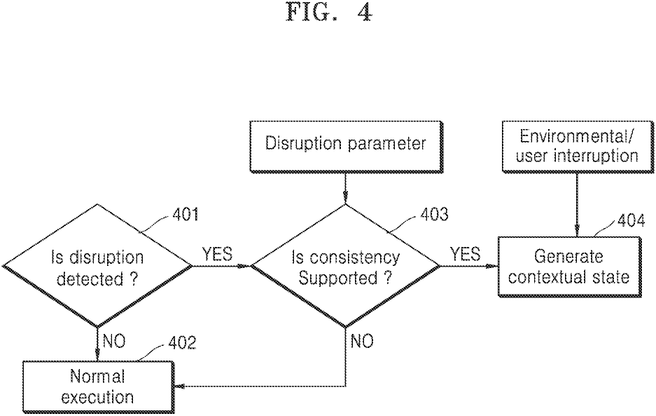

FIG. 4 is a flow diagram illustrating operations in the method of generating the contextual state by the contextual state generator 113, according to an embodiment of the disclosure.

Referring to FIG. 4, the occurrence of the disruption is detected at the disruption detector 112. Referring to FIG. 4, in operation 401, the contextual state generator 113 checks whether the disruption in the task execution is detected, based on identifying detecting the occurrence for the disruption. In operation 402, when the disruption in the task execution is not detected, the contextual state generator 113 instructs the device manager 111 to continue the normal task execution. In operation 403, when the disruption in the task execution is detected, the contextual state generator 113 checks for the consistency of the ongoing task based on the disruption parameter. For example, when the ongoing task is not consistent, the contextual state generator 113 instructs the device manager 111 to continue the normal task execution. In operation 404, when the ongoing task is consistent, the contextual state generator 113 generates the contextual state for the ongoing task by using the environmental interruption or/and user interruption.

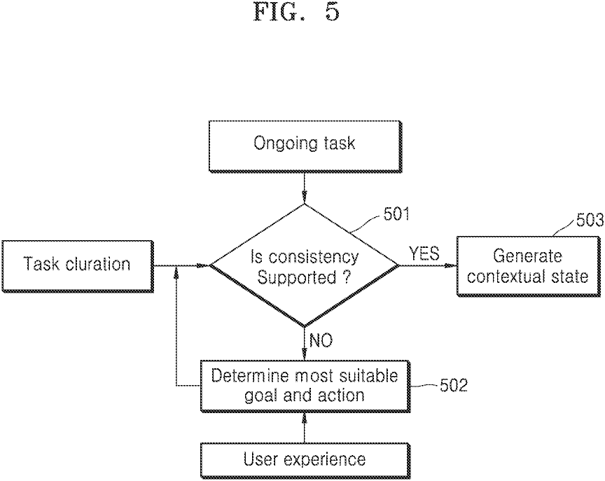

FIG. 5 is a flow diagram illustrating operations in the method of generating the contextual state by the contextual state generator 113, according to an embodiment of the disclosure.

Referring to FIG. 5, in operation 501, the contextual state generator 113 checks whether a goal is known based on the ongoing task and the task duration. In operation 502, when the goal is unknown, then the contextual state generator 113 identifies a most suitable goal by considering a user experience and an action based on current scenarios. In operation 503, when the goal is known, then the contextual state generator 113 generates the contextual state for the ongoing task.

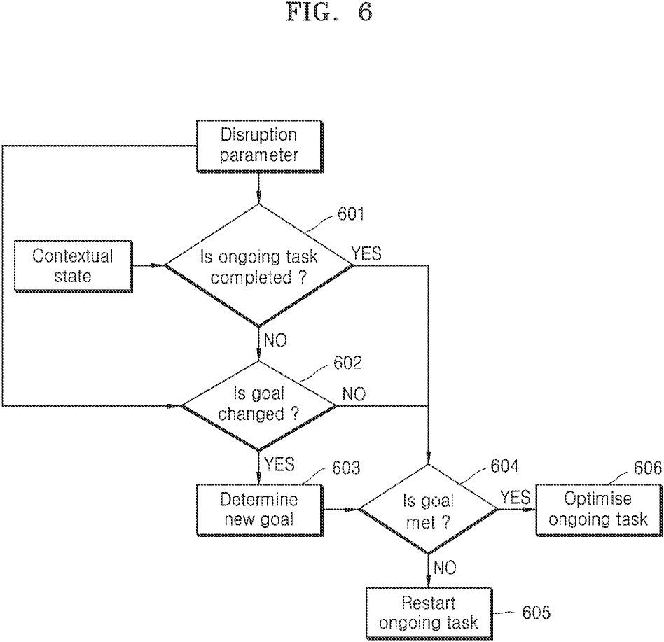

FIG. 6 is a flow diagram illustrating operations in the method of goal auditing, according to an embodiment of the disclosure.

The task optimizer 114 obtains the contextual state from the contextual state generator 113, based on identifying generating the contextual state.

Referring to FIG. 6, in operation 601, the task optimizer 114 identifies whether an ongoing task is completed based on a contextual state and a disruption parameter. In operation 602, based on identifying that the ongoing task is not completed, the task optimizer 114 performs the goal auditing by checking whether the goal is changed or not. In operation 603, based on identifying that the goal is changed, the task optimizer 114 determines a new goal to achieve. In operation 604, based on identifying that the goal is not changed or the ongoing task is completed, the task optimizer 114 checks whether the goal is met. In operation 605, based on identifying that the goal is not met, the task optimizer 114 restarts the ongoing task. In operation 606, based on identifying that the goal is met, the task optimizer 114 optimizes the ongoing task by changing a task duration (i.e. execution time of the ongoing task) and/or adjusting the device settings and/or changing the ongoing task itself.

In one example scenario, the ongoing task is a normal soaking of clothes and the goal is to get clothes wet enough. If the goal has been met i.e. clothes are already wet (the goal has been met) and the soaking task is not finished, the task optimizer 114 optimizes the ongoing task. If the goal has not been met, i.e. the clothes are not wet enough and the soaking task is finished, the task optimizer 114 restarts the soaking task. The various conditions are given in first row and first column of Table 1. An action to be performed by the task optimizer 114 for a combination of the conditions in the first row and the first column are given in remaining boxes of the Table l(goal auditing).

TABLE 1

| | | | | | |
|---|---|---|---|---|---|
| | Task done | Task not done | Goal changed | Goal met | Goal not met |
| Task done | X | X | Optimize task | Normal task execution | Optimize task |
| Task not done | X | X | Optimize task | Optimize task | Optimize task |
| Goal changed | Check if new goal met | Optimize task | X | Normal task execution | Optimize task |
| Goal met | Normal task execution | Optimize task | X | X | X |
| Goal not met | Restart | Optimize task | Check if new goal met | X | X |

In an example, when the task is done and the goal is met, then the task optimizer 114 performs normal task execution. In another example, when the goal is not met and the task is done, then the task optimizer 114 restarts the ongoing task.

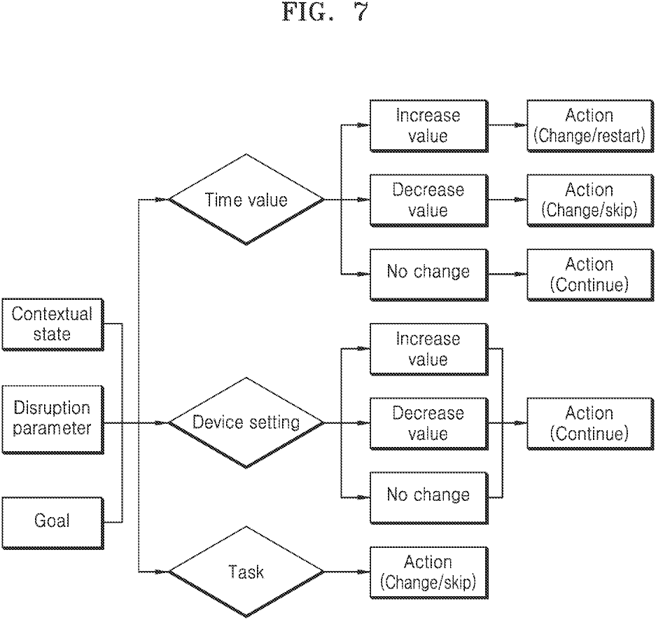

FIG. 7 is a flow diagram illustrating operations in the method of identifying an action by the task optimizer 114, according to an embodiment of the disclosure.

Referring to FIG. 7, the task optimizer 114 optimizes the ongoing task by using the contextual state, disruption parameter, and the goal of the ongoing task. For example, the task optimizer 114 increases or decreases or does not change the time (i.e. time value) of execution of the ongoing task for optimizing the ongoing task. Further, the task optimizer 114 decides the action to change, restart, skip, or continue the ongoing task based on the change or no change in the time value. In an embodiment of the disclosure, the task optimizer 114 increases the time value, decreases the time value, or not changes the device setting for the ongoing task for optimizing the ongoing task. Further, the task optimizer 114 decides the action to continue the ongoing task with the identified change/no change in the device setting. In another embodiment of the disclosure, the task optimizer 114 changes or skips the task based on the contextual state, disruption parameter, and the goal.

In one example scenario, the ongoing task was normal soaking with a soaking time remaining as 30 minutes when suddenly the power cut happened for 20 minutes. Then, the task optimizer 114 analyses that goal of the ongoing task is already met and decreases the time value for the soaking. Further, the task optimizer 114 optimizes the ongoing task as: Action: Change, Time value: Decrease.

In another example scenario, the ongoing task of an air conditioner is in a comfort mode, where the goal of an air conditioner is to keep a room temperature at 18° C. before the disruption. But the goal of the air conditioner is changed due to the environmental disruption (i.e. became evening or raining is started). In an embodiment, the task optimizer 114 calculates a required change in the device settings such as the temperature and the fan speed related to the ongoing task (i.e. comfort mode) based on the disruption parameter (i.e. a drop of temperature due to evening or raining) and the device settings (e.g. room temperate = 18° C. and fan speed = high).) for the ongoing task. Then, the task optimizer 114 optimizes the ongoing task by setting the room temperature to 20° C. and reduces the fan speed.

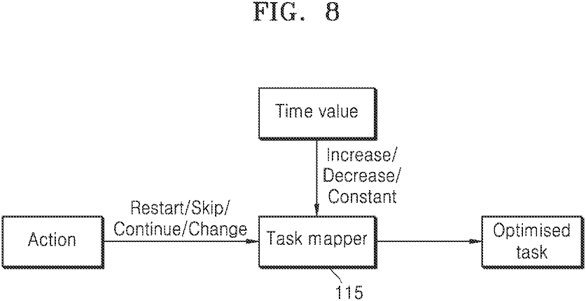

FIG. 8 is a flow diagram illustrating operations in the method of selecting the relevant task by the task mapper 115, according to an embodiment of the disclosure.

Referring to FIG. 8, the task mapper 115 analyses the time value and the action values obtained from the task optimizer 114. Based on the analysis, the task mapper 115 maps the optimized task to the relevant task at the IoT device 210. In an embodiment, the task mapper 115 sends the mapped relevant task and subsequent tasks to the device manager 111, where the device manager 111 further triggers the IoT device 210 to initiate the relevant task and the subsequent tasks. In an embodiment of the disclosure, when the action is skip, then the task mapper 115 instructs the device manager to select the next task to execute. When the action restarts, the task mapper 115 instructs the device manager to restart execution of the ongoing task.

In another embodiment, when the action continues, the task mapper 115 instructs the device manager to continue the execution of the ongoing task until the remaining time to complete the ongoing task. When the action is changed, then the task mapper 115 instructs the device manager to execute the mapped relevant task.

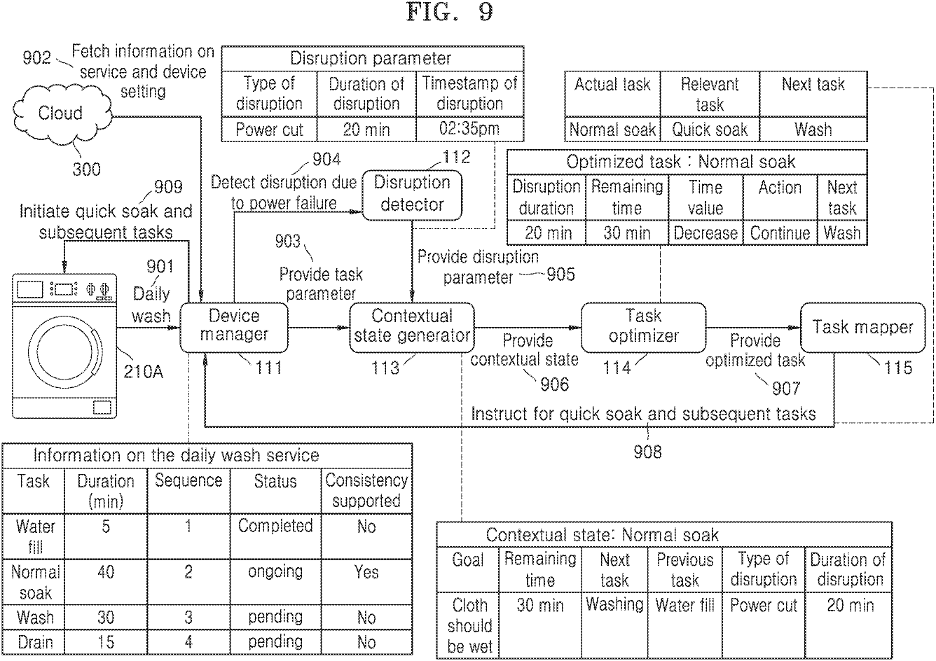

FIG. 9 illustrates an example scenario of optimizing the ongoing task of a washing machine 210A, according to an embodiment of the disclosure.

Referring to FIG. 9, in the example scenario of washing the clothes using the washing machine 210A, a daily wash service is selected at the washing machine 210A for washing the clothes. In one example, the daily wash service includes a water fill task, a normal soak task, a wash task and a drain task, where the normal soak task is currently performing by the washing machine 210A. In operation 901, the device manager 111, for example, detects that the daily wash service is functioning at the washing machine 210A. In operation 902, the device manager 111 fetches the information on the daily wash service and the device setting from the cloud 300. The device manager 111 identifies that the water fill task, the normal soak task, the wash task and the drain task are the tasks in the daily wash service from the information on the daily wash service.

Further, the device manager 111 identifies that 5 minutes, 40 minutes, 30 minutes, 15 minutes as the duration of execution of the water fill task, the normal soak task, the wash task and the drain task respectively from the information on the daily wash service. Further, the device manager 111, for example, identifies that the sequence of execution of the tasks is in the order of the water fill task, the normal soak task, the wash task and the drain task from the information on the daily wash service. Further, the device manager 111 identifies the status of the water fill task, the normal soak task, the wash task and the drain task as completed, ongoing, pending and pending respectively. Still further, the device manager 111, for example, identifies that only normal soak task has the consistency from the information on the daily wash service. In operation 903, the device manager 111 provides the task parameter to the contextual state generator 113 based on the tasks in the service, the duration of execution of the tasks, the sequence of execution of the tasks, the status of the task and the consistency support of the tasks.

In one example, the disruption occurs in executing the normal soak task after 10 minutes of execution due to the power cut at the washing machine 210A, where the timestamp of disruption is 2:35 pm. The duration of disruption is 20 minutes. In operation 904, the disruption detector 112 detects the occurrence of the disruption during executing the normal soak task and identifies the disruption parameter. In operation 905, the disruption detector 112, for example, provides the disruption parameter to the contextual state generator 113. Based on receiving the disruption parameter, the contextual state generator 113 checks whether the normal soak task has consistency support or not. Based on identifying that the normal soak task has the consistency support, the contextual state generator 113 generates the contextual state for the normal soak task. The goal in the contextual state is clothes should be wet. The contextual state, for example, may include remaining time to complete the task execution (i.e. 30 min), the next task (i.e. washing task), the previous task (i.e. water fill task), the type of the disruption (i.e. power cut), and a duration of disruption (i.e. 20 min). In operation 906, the contextual state generator 113 provides the contextual state to the task optimizer 114, based on generating the contextual state.

Based on receiving the contextual state, the task optimizer 114 analyses the contextual state for optimizing the ongoing task. The task optimizer 114, for example, identifies that the clothes need to be soaked for 10 min after disruption is resolved (i.e. resuming the power) at the washing machine 210A based on the analysis. Further, the task mapper 115 identifies that the normal soak task may continue by decreasing the time of execution of the normal soak task based on the analysis. In operation 907, the task optimizer 114 provides the optimized task comprising the time value to decrease the execution time of the ongoing task, the action to continue the ongoing task and the next task to the task mapper 115. In an embodiment, the task mapper 115 maps to the relevant task similar to the optimized task, where the quick soak task is the relevant task with the execution time of 10 min. In operation 908, the task mapper 115 instructs the device manager 111 to execute the quick soak task instead of the normal soak task and continue the subsequent tasks appears after the normal soak task in the sequence. In operation 909, the device manager 111 initiates the quick soak task at the washing machine 210A after resuming the power at the washing machine 210A. Further, the device manager 111 initiates the subsequent tasks appears after the normal soak task in the sequence after completing the quick soak task.

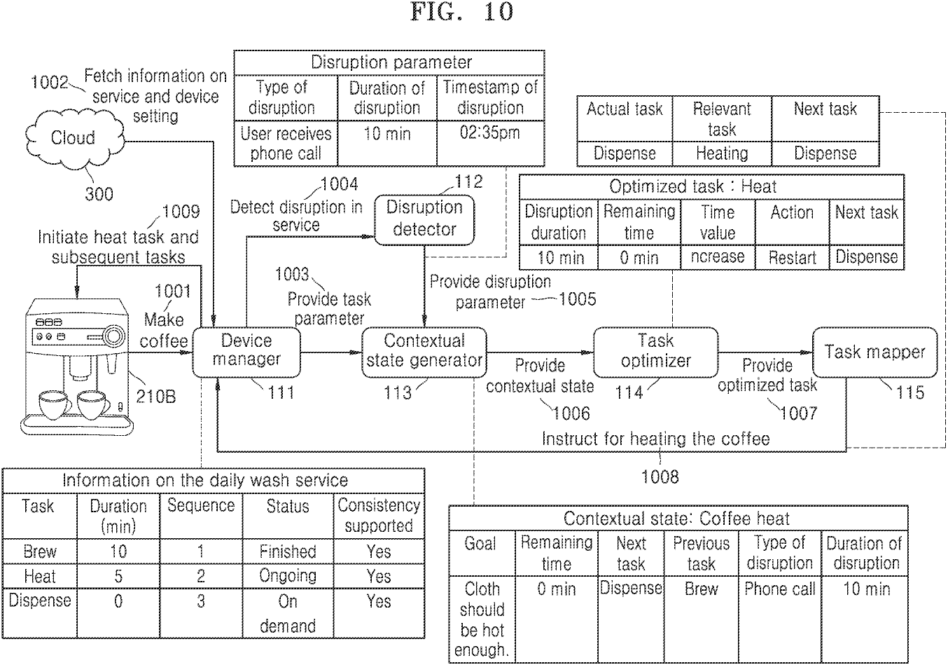

FIG. 10 illustrates an example scenario of optimizing the ongoing task of a coffee maker 210B, according to an embodiment of the disclosure.

Referring to FIG. 10, in the example scenario of making a coffee using the coffee maker 210B, a make coffee service is selected at the coffee maker 210B for making the coffee. For example, the make coffee service includes tasks of brew, heat, and dispense, where the heat task is currently performing by the coffee maker 210B. In operation 1001, the device manager 111 detects that the make coffee service is functioning at the coffee maker 210B. In operation 1002, the device manager 111 fetches the information on the make-coffee-service and the device setting from the cloud 300. In an embodiment, the device manager 111 identifies that the brew, the heat, and the dispense are the tasks in the make-coffee-service from the information on the make-coffee- service.

The device manager 111 identifies that 10 minutes, 5 minutes, 0 minute as the duration of execution of the brew, the heat, and the dispense respectively from the information on the make-coffee-service. In another embodiment, the device manager 111 identifies that the sequence of execution of the tasks is in the order the brew, the heat, and the dispense from the information on the make-coffee-service. Further, the device manager 111 identifies the status of the brew, the heat, and the dispense as finished, ongoing, and on-demand respectively. In yet another embodiment, the device manager 111 identifies that all the tasks have the consistency from the information on the make coffee service. In operation 1003, the device manager 111 provides the task parameter to the contextual state generator 113 based on the tasks in the service, the duration of execution of the tasks, the sequence of execution of the tasks, the status of the task and the consistency support of the tasks.

In an IoT network, IoT devices interconnect each other and recognize status of other devices if permitted. In the embodiment depicted in FIG. 10, the coffee maker 210B may recognize a status of user’s phone that is idle, incoming/outgoing a phone call, or in use.

For example, the user is busy with a phone call from 2:30 pm (i.e. the timestamp of disruption) while the coffee maker 210B is executing the heating task. The duration of disruption is for 10 min. In operation 1004, the disruption detector 112 detects the occurrence of the disruption while executing the heating task and identifies the disruption parameter. In operation 1005, the disruption detector 112 provides the disruption parameter to the contextual state generator 113. Based on receiving the disruption parameter, the contextual state generator 113, for example, checks whether the heat task has consistency support or not. Based on identifying that the heat task has the consistency support, the contextual state generator 113 generates the contextual state for the heat task. The goal in the contextual state is the coffee should be hot enough. The contextual state, for example, may include remaining time to complete the task execution (i.e. 0 minute), the next task (i.e. dispense), the previous task (i.e. brew), the type of the disruption (i.e. phone call), and the duration of disruption (i.e. 10 minutes).

In operation 1006, the contextual state generator 113 provides the contextual state to the task optimizer 114, based on generating the contextual state. Based on receiving the contextual state, the task optimizer 114, for example, analyses the contextual state for optimizing the ongoing task. The task optimizer 114, for example, identifies that the coffee needs to heat for some time after disruption is resolved (i.e. user hang up the phone call) at the coffee maker 210B based on the analysis. Further, the task mapper 115 identifies that the heat task may restart based on the analysis. In operation 1007, the task optimizer 114 provides the optimized task comprising the time value to increase, the action to restart the ongoing task and the next task to the task mapper 115. The task mapper 115, for example, maps to the relevant task as the heat task. In operation 1008, the task mapper 115 instructs the device manager 111 to execute the heat task and continue the subsequent tasks. In operation 1009, the device manager 111 initiates the heat task and the subsequent tasks at the coffee maker 210B based on detecting that the user disconnects the phone call.

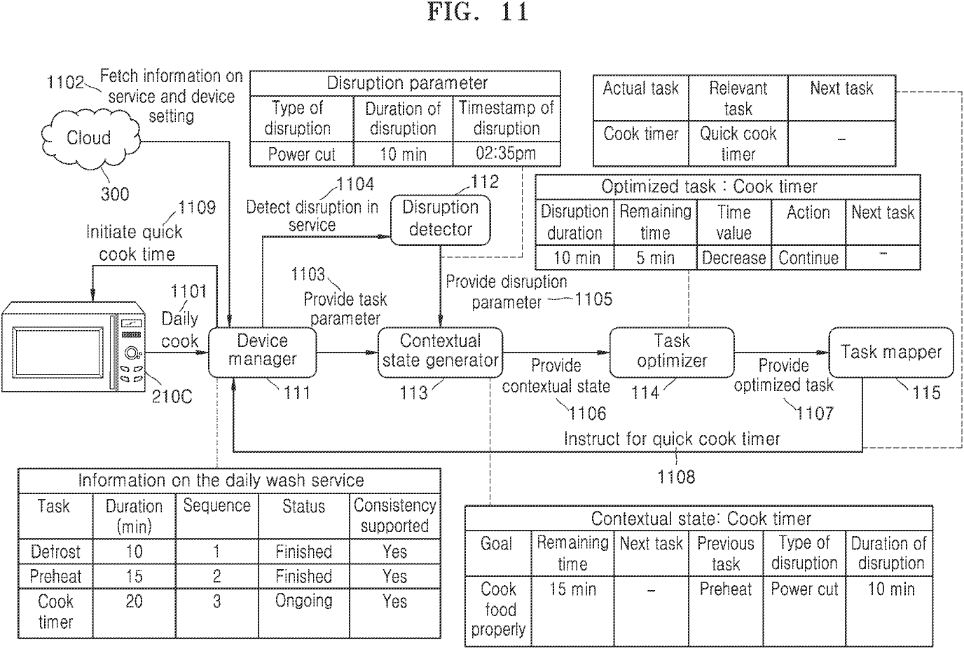

FIG. 11 illustrates example scenarios of optimizing the ongoing task of an oven 210C, according to an embodiment of the disclosure.

Referring to FIG. 11, in the example scenario of cooking a food using the oven 210C, a daily cook service is selected at the oven 210C for cooking the food. In an example, the daily cook service includes a defrost task, a preheat task, and a cook timer task, where the cook timer task is currently performing by the oven 210C. In operation 1101, the device manager 111, for example, detects that the daily cook service is functioning at the oven 210C. In operation 1102, the device manager 111 fetches the information on the daily cook service and the device setting from the cloud 300. The device manager 111, for example, identifies that the defrost task, the preheat task, and the cook timer task are the tasks in the daily cook service from the information on the daily cook service. Further, the device manager 111, for example, identifies that 10 min, 15 min, 20 min as the duration of execution of the defrost task, the preheat task, and the cook timer task respectively from the information on the daily cook service.

Further, the device manager 111 identifies that the sequence of execution of the tasks is in the order the defrost task, the preheat task, and the cook timer from the information on the daily cook service. Still further, the device manager 111 identifies the status of the defrost task, the preheat task, and the cook timer task as finished, finished, and ongoing respectively. The device manager 111, for example, identifies that all the tasks have the consistency from the information on the daily cook service. In operation 1103, the device manager 111, for example, provides the task parameter to the contextual state generator 113 based on the tasks in the service, the duration of execution of the tasks, the sequence of execution of the tasks, the status of the task and the consistency support of the tasks.

In an example, the disruption occurs in executing the cook timer after 5 minutes of execution due to the power cut at the oven 210C, where the timestamp of disruption is 2:35 pm. The duration of disruption is for 10 min. In operation 1104, the disruption detector 112, for example, detects the occurrence of the disruption in executing the cook timer task and identifies the disruption parameter. In operation 1105, the disruption detector 112, for example, provides the disruption parameter to the contextual state generator 113. Based on receiving the disruption parameter, the contextual state generator 113 checks whether the cook timer task has consistency support or not. Based on identifying that the cook timer task has the consistency support, the contextual state generator 113 generates the contextual state for the cook timer task. The goal in the contextual state is to cook the food properly. The contextual state, for example, may include remaining time to complete the task execution (i.e. 15 min), the previous task (i.e. preheat task), the type of the disruption (i.e. power cut), and a duration of disruption (i.e. 10 min), where no next task is available.

In operation 1106, the contextual state generator 113 provides the contextual state to the task optimizer 114, based on generating the contextual state. Based on receiving the contextual state, the task optimizer 114, for example, analyses the contextual state for optimizing the ongoing task. The task optimizer 114, for example, identifies that the food needs to cook for 5 min after disruption is resolved (i.e. resuming the power) at the oven 210C based on the analysis. Further, the task mapper 115 identifies that the cook timer task may continue by decreasing the time of execution of cook timer task based on the analysis. In operation 1107, the task optimizer 114 provides the optimized task comprising the time value to decrease the execution time of the ongoing task, and the action to continue the ongoing task to the task mapper 115. Still further, the task mapper 115 maps to the relevant task similar to the optimized task, where the quick cook timer task is the relevant task having the execution time of 5 min. In operation 1108, the task mapper 115 instructs the device manager 111 to execute the quick cook timer task instead of the cook timer task. In operation 1109, the device manager 111 initiates the quick cook timer task at the oven 210C after resuming the power at the oven 210C

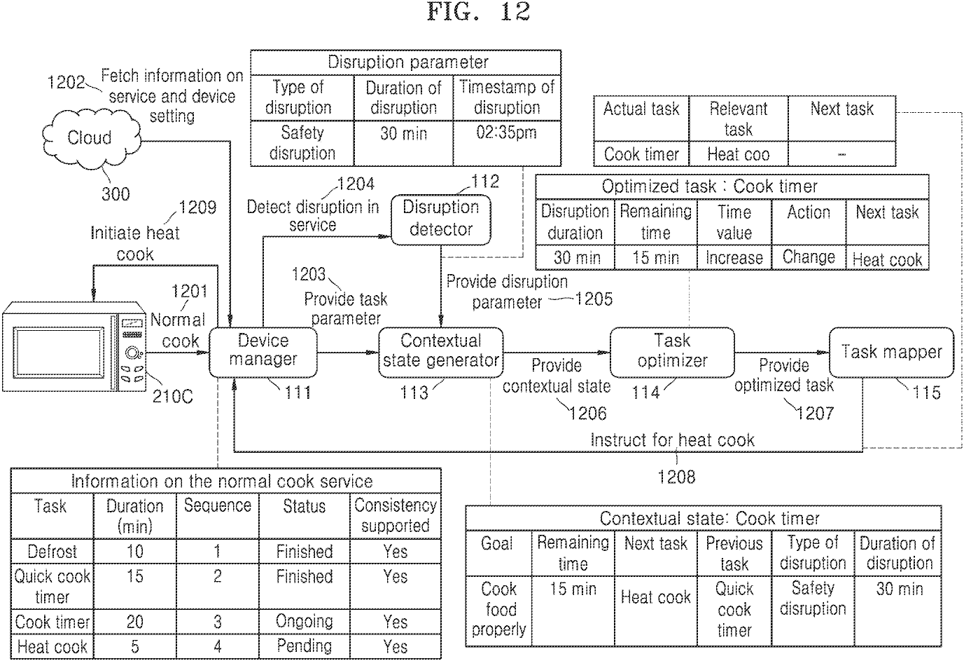

FIG. 12 illustrates example scenarios of optimizing the ongoing task of an oven 210C, according to an embodiment of the disclosure.

Referring to FIG. 12, in the example scenario of cooking the food using the oven 210C, a normal cook service is selected at the oven 210C for cooking the food. In an example, the normal cook service includes a defrost task, a quick cook timer task, a cook timer task, and a heat cook task where the cook timer task is currently performing by the oven 210C. In operation 1201, the device manager 111, for example, detects that the normal cook service is functioning at the oven 210C. In operation 1202, the device manager 111, for example, fetches the information on the normal cook service and the device setting from the cloud 300. The device manager 111 identifies that the defrost task, the quick cook timer task, the cook timer task, and the heat cook task are the tasks in the normal cook service from the information on the normal cook service. Further, the device manager 111, for example, identifies that 10 min, 15 min, 20 min, 5 min as the duration of execution of the defrost task, the quick cook timer task, the cook timer task, and the heat cook task respectively from the information on the normal cook service.

Further, the device manager 111 identifies that the sequence of execution of the tasks is in the order the defrost task, the quick cook timer task, the cook timer task, and the heat cook task from the information on the normal cook service. Further, the device manager 111, for example, identifies the status of the defrost task, the quick cook timer task, the cook timer task, and the heat cook task as finished, finished, ongoing, pending respectively. Still further, the device manager 111, for example, identifies that all the tasks have the consistency from the information on the normal cook service. In operation 1203, the device manager 111 provides the task parameter to the contextual state generator 113 based on the tasks in the service, the duration of execution of the tasks, the sequence of execution of the tasks, the status of the task and the consistency support of the tasks.

In an example, the user accidently left the lid of the oven 210C open after 5 minutes of execution of the cook timer task. The device manager 111, for example, interrupts the execution of the cook timer task due to a safety issue in executing the cook timer task while the lid is open. Further, the duration of disruption is identified as 30 minutes and the timestamp of the disruption is 2:35 pm. In operation 1204, the disruption detector 112 detects the occurrence of the disruption in executing the cook timer task and identifies the disruption parameter. In operation 1205, the disruption detector 112, for example, provides the disruption parameter to the contextual state generator 113. Based on receiving the disruption parameter, the contextual state generator 113 checks whether the cook timer task has consistency support or not. Based on identifying that the cook timer task has the consistency support, the contextual state generator 113 generates the contextual state for the cook timer task. The goal in the contextual state is to cook the food properly.

The contextual state may include remaining time to complete the task execution (i.e. 15 minutes), the next task (i.e. heat cook task), the previous task (i.e. quick cook timer task), the type of the disruption (i.e. safety disruption), and a duration of disruption (i.e. 30 minutes). In operation 1206, the contextual state generator 113, for example, provides the contextual state to the task optimizer 114, based on generating the contextual state. Based on receiving the contextual state, the task optimizer 114 analyses the contextual state for optimizing the ongoing task. The task optimizer 114, for example, identifies that the food needs to cook for 5 minutes after disruption is resolved (i.e. closing the lid) of the oven 210C based on the analysis. Further, the task mapper 115 identifies that the cook timer task may change and increasing the time of execution of the cook timer task based on the analysis. In operation 1207, the task optimizer 114 provides the optimized task comprising the time value to increase the execution time of the ongoing task, and the action to continue the ongoing task to the task mapper 115. In an embodiment, the task mapper 115 maps to the relevant task similar to the optimized task, where the heat cook task is the relevant task having the execution time of 5 min. In operation 1208, the task mapper 115 instructs the device manager 111 to execute the heat cook task. In operation 1209, the device manager 111 initiates the heat cook task at the oven 210C after closing the lid of the oven 210C.

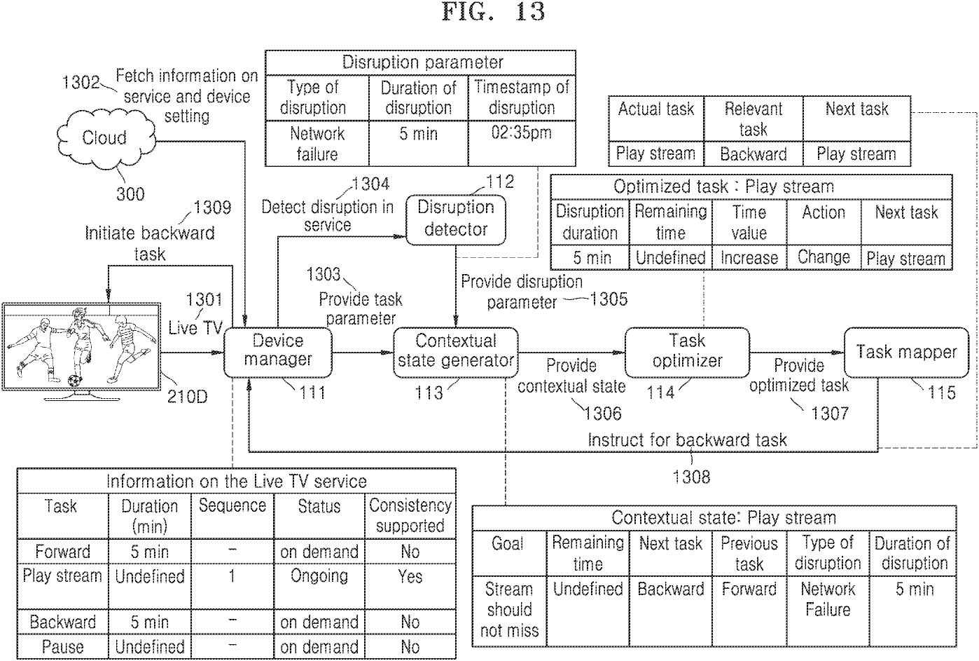

FIG. 13 illustrates an example scenario of optimizing the ongoing task of a Television (TV) 210D, according to an embodiment of the disclosure.

Referring to FIG. 13, in the example scenario of playing a live steam using the TV 210D, a live TV service is selected at the TV 210D for playing the live steam. In one example, the live TV service includes a forward task, a play stream task, a backward task and a pause task, where the play stream task is currently executing by the TV 210D. In operation 1301, the device manager 111, for example, detects that the live TV service is functioning at the TV 210D. In operation 1302, the device manager 111 fetches the information on the live TV service and the device setting from the cloud 300. The device manager 111 identifies that the forward task, the play stream task, the backward task and the pause task are the tasks in the live TV service from the information on the live TV service.

Further, the device manager 111 identifies that 5 minutes as the duration of execution of the forward task, undefined time as the play stream task, 5 minutes as the backward task, and undefined time as the pause task respectively from the information on the live TV service. Still further, the device manager 111, for example, identifies the status of the forward task as on-demand, the play stream task as ongoing, the backward task as on demand, and the pause task as on-demand respectively. The device manager 111 identifies that only the play stream task has the consistency from the information on the live TV service. In operation 1303, the device manager 111, for example, provides the task parameter to the contextual state generator 113 based on the tasks in the service, the duration of execution of the tasks, the status of the task and the consistency support of the tasks.

For example, the disruption occurs in executing the play stream task for 5 minutes due to a networking issue at the TV 210D, where the timestamp of disruption is 2:35 pm. In operation 1304, the disruption detector 112, for example, detects the occurrence of the disruption while executing the play stream task and identifies the disruption parameter. In operation 1305, the disruption detector 112, for example, provides the disruption parameter to the contextual state generator 113. Based on receiving the disruption parameter, the contextual state generator 113 checks whether the play stream task has consistency support or not. Based on identifying that the play stream task has the consistency support, the contextual state generator 113, for example, generates the contextual state for the play stream task. The goal in the contextual state is that the stream should not be missed. The contextual state may include remaining time to complete the task execution (i.e. undefined), the next task (i.e. backward), the previous task (i.e. forward), the type of the disruption (i.e. network failure), and the duration of disruption (i.e. 5 minutes).

In operation 1306, the contextual state generator 113 provides the contextual state to the task optimizer 114, based on generating the contextual state. Based on receiving the contextual state, the task optimizer 114 analyses the contextual state for optimizing the ongoing task. The task optimizer 114, for example, identifies that the live stream needs to play backward for 5 min after disruption is resolved (i.e. solving the network issue) at the TV 210D based on the analysis. Further, the task mapper 115 identifies that the backward task may execute based on the analysis. In operation 1307, the task optimizer 114 provides the optimized task comprising the time value to increase, the action to change the ongoing task and the next task to the task mapper 115. The task mapper 115, for example, maps to the relevant task as the backward task. In operation 1308, the task mapper 115 instructs the device manager 111 to execute the backward task and continue the subsequent tasks. In operation 1309, the device manager 111 initiates the backward task and the subsequent tasks at the TV 210D based on detecting that the network issue is resolved.

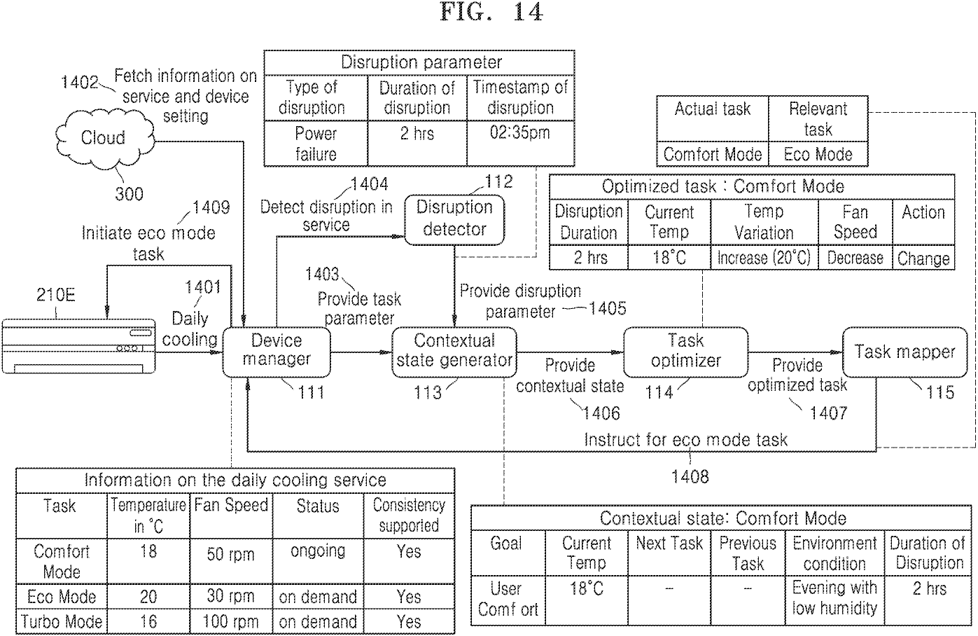

FIG. 14 illustrates an example scenario of optimizing the ongoing task of an Air Conditioner (AC) 210E, according to an embodiment of the disclosure.

Referring to FIG. 14, in an example scenario of maintaining a temperature in a room using the AC 210E, a daily cooling service is selected at the AC 210E for cooling the air. In an example, the daily cooling service includes a comfort mode task, an eco-mode task, and a turbo mode task, where the comfort mode task is currently performing by the AC 210E. In operation 1401, the device manager 111, for example, detects that the daily cooling service is functioning at the AC 210E. In operation 1402, the device manager 111 fetches the information on the daily cooling service and the device setting from the cloud 300. The device manager 111, for example, identifies that the comfort mode task, the eco-mode task, and the turbo mode task are the tasks in the daily cooling service from the information on the daily cooling service. Further, the device manager 111 identifies that 18° C., 20° C., 16° C. are the temperature to maintain inside the room while executing the comfort mode task, the eco-mode task, and the turbo mode task respectively from the information on the daily cooling service.

In an embodiment, the device manager 111 identifies that the fan speed should be 50 rotation per minute (rpm), 30 rpm, 100 rpm during the execution of the comfort mode task, the eco-mode task, and the turbo mode task respectively from the information on the daily cooling service. Further, the device manager 111, for example, identifies the status of the comfort mode task, the eco-mode task, and the turbo mode task as ongoing, on demand, and on demand respectively from the information on the daily cooling service. In another embodiment, the device manager 111 identifies that all the tasks have the consistency from the information on the daily cooling service. Further, the device manager 111 identifies the environmental condition as day time with high humidity while executing the ongoing task, where the ambient temperature is high (32° C.). In operation 1403, the device manager 111, for example, provides the task parameter to the contextual state generator 113 based on the tasks in the service, the temperature to maintain in the room according to the tasks, the fan speed according to the tasks, the status of the task, the consistency support of the tasks and the environmental condition.

In another example, the disruption occurs in executing the comfort mode task due to the power cut at the AC 210E, where the timestamp of disruption is 2:35 pm. The duration of disruption is for 2 hours. In operation 1404, the disruption detector 112, for example, detects the occurrence of the disruption in executing the comfort mode task and identifies the disruption parameter. In operation 1405, the disruption detector 112 provides the disruption parameter to the contextual state generator 113. Based on receiving the disruption parameter, the contextual state generator 113, for example, checks whether the comfort mode task has consistency support or not. Based on identifying that the comfort mode task has the consistency support, the contextual state generator 113 generates the contextual state for the comfort mode task. In an example, the environmental condition changes to evening with low humidity after 2 hours of disruption, where the ambient temperature is low. Based on detecting the change in the environmental condition, the contextual state generator 113 updates the contextual state for the comfort mode task.

The goal in the contextual state is to make user comfort by maintaining optimal temperature in the room. The contextual state may include current temperature (i.e. 18° C.), the next task (i.e. not available), the previous task (i.e. not available), the environmental condition (i.e. evening with low humidity), and a duration of disruption (i.e. 2 hrs). In operation 1406, the contextual state generator 113 provides the contextual state to the task optimizer 114, based on generating the contextual state. Based on receiving the contextual state, the task optimizer 114 analyses the contextual state for optimizing the ongoing task. The task optimizer 114 identifies that the ambient temperature is reduced, hence the temperature in room may be increased to 20° C. after disruption is resolved (i.e. resuming the power) at the AC 210E based on the analysis. Further, the task mapper 115, for example, identifies that the comfort mode task may change by decreasing the fan speed based on the analysis. In operation 1407, the task optimizer 114 provides the optimized task comprising the fan speed to decrease, and the action to change the ongoing task to the task mapper 115. The task mapper 115 maps to the relevant task similar to the optimized task, where the eco mode task is the relevant task having the reduced fan speed with respect to that of the comfort mode task. In operation 1408, the task mapper 115, for example, instructs the device manager 111 to execute the eco mode task instead of the comfort mode task. In operation 1409, the device manager 111 initiates the eco mode task at the AC 210E after resuming the power at the AC 210E.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for context-based task management in an Internet of Thing (IoT) network, comprising:
detecting, by an IoT controller device, an occurrence of a disruption while executing an ongoing task at an IoT device in the IoT network;
identifying, by the IoT controller device, a contextual relationship between the ongoing task and the disruption; and
performing, by the IoT controller device, one of:
continuing the ongoing task at the IoT device based on the contextual relationship between the ongoing task and the disruption,
initiating an alternative task for the ongoing task at the IoT device based on the contextual relationship between the ongoing task and the disruption, and
proceeding with a next task of the ongoing task at the IoT device based on the contextual relationship between the ongoing task and the disruption.

2. The method of claim 1,
wherein the identifying of the contextual relationship between the ongoing task and the disruption comprises:
identifying the contextual relationship between the ongoing task and the disruption based on at least one parameter associated with the disruption, and
wherein at least one parameter associated with the ongoing task, and a context of the IoT device.

3. The method of claim 2, wherein the at least one parameter associated with the disruption comprises:
at least one of a type of the disruption,
a duration of the disruption, and
a timestamp of the disruption.

4. The method of claim 2, wherein the at least one parameter associated with the ongoing task comprises:
at least one of a previous task of the ongoing task,
the next tasks of the ongoing task,
a status of the ongoing task,
a duration of the ongoing task,
a consistency support of the ongoing task, and
a sequence of the ongoing task.

5. The method of claim 2, wherein the context of the IoT device comprises:
at least one of an environmental condition around the IoT device,
a proximity of the IoT device to a user of the IoT device,
an action performing by the user, and
an operation condition of the IoT device.

6. The method of claim 1, wherein the proceeding with the next task of the ongoing task at the IoT device based on the contextual relationship between the ongoing task and the disruption, comprises:
identifying, by an IoT controller device, that the ongoing task is completed based on the contextual relationship between the ongoing task and the disruption; and
performing, by the IoT controller device, one of:
assigning the next task to the IoT device based on at least one parameter associated with the ongoing task, based on identifying that ongoing task is completed, and
modifying the ongoing task based on the context of the IoT device, the at least one parameter associated with the disruption and the at least one parameter associated with the ongoing task, based on identifying that the ongoing task is not completed.

7. The method of claim 1, wherein the initiating of the alternative task for the ongoing task at the IoT device based on the contextual relationship between the ongoing task and the disruption, comprises:
identifying a goal of the ongoing task based on a context of the ongoing task;
estimating a remaining time to achieve the goal of the ongoing task based on at least one parameter associated with the disruption and the at least one parameter associated with the ongoing task; and
generating a new list of tasks for assigning to the IoT device based on the remaining time to achieve the goal, the goal of the ongoing task and the context of the IoT device.

8. The method of claim 7, wherein the generating of the new list of tasks for assigning to the IoT device based on the remaining time to achieve the goal, the goal of the ongoing task and the context of the IoT device, comprises:
performing, by the IoT device, one of:
adjusting a duration for an execution of the ongoing task based on the remaining time to achieve the goal, and
adjusting at least one device setting configured for an execution of the ongoing task based on the remaining time to achieve the goal of the ongoing task.

9. An IoT controller device for context-based task management in an Internet of Thing (IoT) network, comprising:
at least one memory storing a program,
wherein execution of the program is performed by at least one processor, and
wherein the at least one processor, coupled to the at least one memory, configured to:
detect an occurrence of a disruption while executing an ongoing task at an IoT device in the IoT network,
identify a contextual relationship between the ongoing task and the disruption, and
perform one of:
continuing of the ongoing task at the IoT device based on the contextual relationship between the ongoing task and the disruption,
initiating an alternative task for the ongoing task at the IoT device based on the contextual relationship between the ongoing task and the disruption, and
proceeding with a next task of the ongoing task at the IoT device based on the contextual relationship between the ongoing task and the disruption.

10. The IoT controller device of claim 9,
wherein the at least one processor is further configured to:
identify the contextual relationship between the ongoing task and the disruption based on at least one parameter associated with the disruption, and
wherein at least one parameter associated with the ongoing task, and a context of the IoT device.

11. The IoT controller device of claim 10, wherein the at least one parameter associated with the disruption comprises:
at least one of a type of the disruption,
a duration of the disruption, and
a timestamp of the disruption.

12. The IoT controller device of claim 9, wherein the at least one processor configured to perform the proceeding with the next task of the ongoing task at the IoT device based on the contextual relationship between the ongoing task and the disruption is further configured for:
identifying, by the IoT controller device, that the ongoing task is completed based on the contextual relationship between the ongoing task and disruption; and
performing, by the IoT controller device, one of:
assigning the next task to the IoT device based on at least one parameter associated with the ongoing task, based on identifying that the ongoing task is completed, and
modifying the ongoing task based on the context of the IoT device, the at least one parameter associated with the disruption and the at least one parameter associated with the ongoing task, based on identifying that the ongoing task is not completed.

13. The IoT controller device of claim 9, wherein the at least one processor configured to perform the initiating of the alternative task for the ongoing task at the IoT device based on the contextual relationship between the ongoing task and the disruption is further configured for:
identifying a goal of the ongoing task based on a context of the ongoing task;
estimating a remaining time to achieve the goal of the ongoing task based on at least one parameter associated with the disruption; and
generating a new list of tasks for assigning to the IoT device based on the remaining time to achieve the goal, the goal of the ongoing task and the context of the IoT device.

14. The IoT controller device of claim 13, wherein the at least one processor configured to perform the generating of the new list of tasks for assigning to the IoT device based on the remaining time to achieve the goal, the goal of the ongoing task and the context of the IoT device is further configured for:
performing, by the IoT device, one of:
adjusting a duration for an execution of the ongoing task based on the remaining time to achieve the goal, and
adjusting at least one device setting configured for an execution of the ongoing task based on the remaining time to achieve the goal of the ongoing task.

15. A non-transitory computer-readable recording medium configured to store one or more computer programs including instructions that, when executed by at least one processor, cause the at least one processor to:
detect an occurrence of a disruption while executing an ongoing task at an IoT device in an Internet of Thing (IoT) network,
identify a contextual relationship between the ongoing task and the disruption, and
perform one of:
continuing the ongoing task at the IoT device based on the contextual relationship between the ongoing task and the disruption,
initiating an alternative task for the ongoing task at the IoT device based on the contextual relationship between the ongoing task and the disruption, and
proceeding with a next task of the ongoing task at the IoT device based on the contextual relationship between the ongoing task and the disruption.
